(19) United States
(12) Patent Application Publication
(10) Pub. No.: US 2006/0271375 A1
(43) Pub. Date: Nov. 30, 2006

(54) Project information providing system and project information providing method

(76) Inventors: Hiroyoshi Yamada, Kanagawa (JP); Hideki Kato, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/549,755

(22) PCT Filed: Mar. 24, 2003
(86) PCT No.: PCT/JP03/03501

§ 371 Date: Sep. 21, 2005

(51) Int. Cl. G06Q 99/00

(52) U.S. Cl. 705/1

(57) ABSTRACT

By managing and providing information such as know-how from a product using registration of the product as a trigger, it is possible to rapidly and effectively provide information on a project product. As a result, for example, it is possible to provide timely service utilizing this information.

### TECHNICAL FIELD

The present invention relates to a project information providing system providing information (for example, know-how) related to a project.

### BACKGROUND ART

The progress of a project is registered in a project management system. Here, the project means, for example, a development project developing a predetermined program and so forth. The progress and products (a specification, a program itself as a final result and so forth) of the project are registered in the project management system to become available for a person in charge of the project (project member) to refer.

In order to accomplish a project, a variety of information is required. In that case, the required information can be acquired by searching products of the other project using the project management system.

The acquisition of the project-related information is usable not only for developing in the project, but also for providing information or services to clients.

As to the project information acquisition, there are disclosed arts as described below.

In Japanese Patent Laid-Open Application No. Hei 9-16392, there is disclosed a software development support system enabling to acquire relevant products easily when making a modification to a certain product, in which an association is established between each of every product.

In Japanese Patent Laid-Open Application No. Hei 8-137901, there is disclosed a product information management device capable of managing product information up to the completion of a project appropriately, in which product information is collected and registered when the product information is inputted and a key information of the project is changed when the completion of the project is detected.

### DISCLOSURE OF THE INVENTION

In order to acquire project information in conventional systems, a person who requires the information has to search the project registered in the project management system. In other words, the search of the project information is not performed until the person being a receiver of the information feels a need of the information.

Meanwhile, the required information is not always well-defined in the course of the project in a lot of cases. When the required information is clearly defined, frequently, a problem is already apparent (for instance, a case where a problem arose when running a program.) A problem solving possibly takes a lot of time when searching a solution after the problem arose.

Also, when providing information or a service to a customer, it is not always easy to provide information contents being appropriate for each customer. For a service provider providing services to customers, a provision of a service being appropriate for each customer requires to know well about the customer's information to always search the information for the customer's information for the customer continuously. This is an overload operation for the service provider.

However, when information is provided at random, the customer being an information receiver has to select information that the customer actually wants. This means that, even when there is information effectively usable, the costumer has to select the information he/she wants from among a large amount of information. When the customer wants to use the electively-usable information while it is very fresh, the customer has to repeat to search again and again, possibly leading to a higher cost.

The present invention has been made in consideration of the viewpoints described above, and an object thereof is to provide a project information providing system providing information on a project product rapidly and effectively.

A. The project information providing system according to the present invention is characterized in that the project information providing system includes: a product registration unit registering a product of a project; an information management unit managing information contained in the product using the registration of the product by the product registration unit as a trigger; and an information providing unit selecting and providing information contained in the product using the registration of the product by the product registration unit as a trigger.

By performing management and provision of information contained in a product such as know-how using the registration of the product as a trigger, it is possible to rapidly accumulate and provide the information such as know-how. As a result, for example, it is possible to provide timely service utilizing this information.

By preparing a table to provide information, it is possible to rapidly select and provide information. For instance, by setting a criterion for selecting information for each customer (service receiver), it is possible to timely provide information to the customer.

This table can be realized as a know-how map when the information is know-how. Note that the table may be divided into that for management and that for provision, whereas a single integrated table causes no problem.

(1) The table may record information enabling to refer to contents recorded in the other table.

By referring to the other table related to a certain table, more various information can be selected to be provided.

In that case, when the table is in a hierarchical relation with the other table, there arises no problem.

For instance, by performing a hierarchical management of the table from each project level to an organization or entire company level, it is possible to register and provide information by classifying the information into those specific to a project having limited scope of application but having high added-value and those with relatively small effect of application but is commonly usable.

(2) The table may record information indicating priorities for the information selection and provision.

By giving priorities, it is possible to easily determine usability of information, so that the burden on information selection can be reduced.

B. The project information providing method according to the present invention is characterized in that the information providing method includes: a step of product registration registering a product of a project; a step of information management managing information contained in the product using the registration of the product in the product registration step as a trigger; and a step of information provision selecting and providing information managed in the information management step.

By performing the selection and provision of information such as know-how from a product using the registration of the product as a trigger, it is possible to rapidly accumulate and provide the information such as know-how.

### BRIEF DESCRIPTION OF DRAWINGS

FIG. 1 is a block diagram showing a configuration of a project information providing system according to an embodiment of the present invention.

FIGS. 2A and 2B are diagrams schematically showing an outline of a know-how provision in the project information providing system according to the embodiment of the present invention and that in a conventional system, respectively.

FIG. 3 is a conceptual view showing an example product to be registered in a product DB by a product registration unit.

FIG. 4 is a schematic diagram showing an example know-how map.

FIG. 5 is a schematic diagram showing a hierarchical structure (management pattern) of the know-how map.

FIG. 6 is a schematic diagram showing a relation between a product and a know-how contained in the product in the case where the product is a test specification and a test report.

FIGS. 7A and 7B are schematic diagrams showing an example know-how map.

FIGS. 8A to 8C are schematic diagrams showing an example know-how map for provision and example know-how maps for management related thereto.

FIG. 9 is a flowchart showing an outline of operating procedures of the project information providing system.

FIG. 10 is a flowchart showing procedures of a detailed update processing of the know-how map by a know-how map updating unit.

FIG. 11 is a flowchart showing procedures such as a know-how selection by a know-how map reference unit.

### BEST MODE FOR IMPLEMENTING THE INVENTION

Hereinafter, a mode according to the present invention will be described in detail with reference to the drawings.

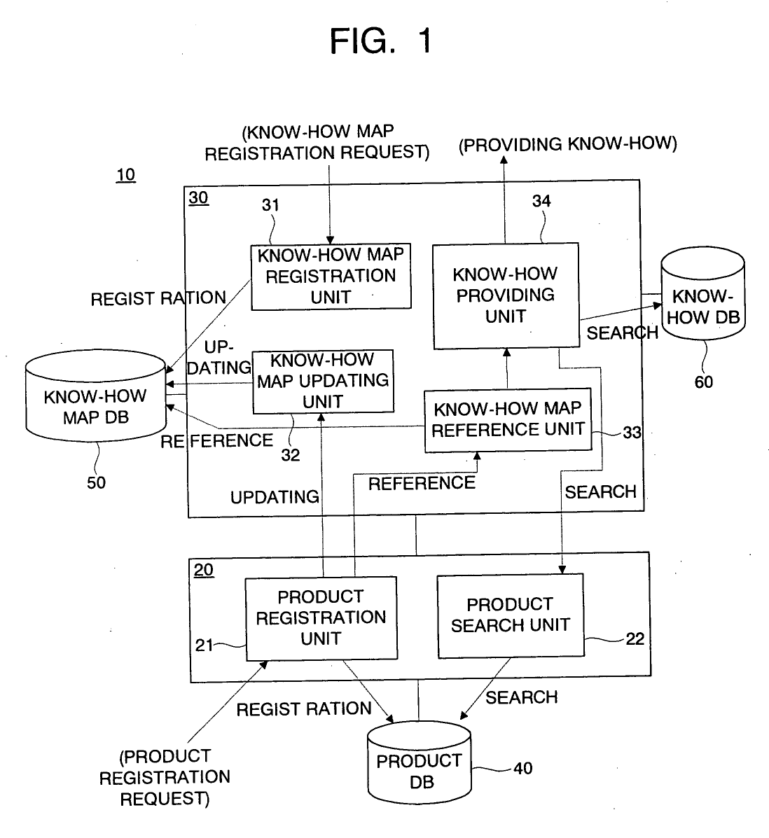

FIG. 1 is a block diagram showing a configuration of a project information providing system 10 according to the mode of the present invention.

As shown in FIG. 1, the project information providing system 10 is composed of a project management system 20 and a knowledge-based system 30, and a product database (DB) 40, a know-how map database (DB) 50 and a know-how database (DB) 60 connected thereto.

Note that the project information providing system 10 is segmented into the project management system 20 and the knowledge-based system 30 for the purpose of convenience, so that the project information providing system 10 may be realized as a single system.

The project management system 20 is to manage a project itself and products of the project, and includes a product registration unit 21 and a product search unit 22.

The knowledge-based system 30 is to manage know-how (usable technical knowledge related to the project), and includes a know-how map registration unit 31, a know-how map updating unit 32, a know-how map reference unit 33, and a know-how providing unit 34.

The product DB 40, know-how map DB 50 and know-how DB 60 are storage devices storing a product, a know-how map and a know-how, respectively.

The product means every product generated in the course of accomplishing the project such as a specification (for example, a program specification defining the specification of a program, a test specification defining the specification of a program test), a report (a test report recording the test result of a program), a program itself produced in the project and so forth. Note that the details and a specific example of the product will be described later.

The know-how map is the information to manage know-how form plural viewpoints. The know-how maps are divided into two types, namely a know-how map for management to manage know-how contained in the product and a know-how map for provision to provide the know-how. Note that the details of the know-how map will be described later.

The product registration unit 21 accepts a registration request for a product to register the product in the product DB 40. The product registration unit 21 boots the know-how map updating unit 32 and know-how map reference unit 33 when registering the product in the product DB 40. As a result, the management, selection and provision of the know-how are performed at the time of the product registration as a trigger (event or stimulus). Note that the booting of the know-how map updating unit 32 and know-how map reference unit 33 is not necessary carried out together with the product registration. There is no problem when the bootings of the know-how map updating unit 32 and know-how map reference unit 33 are carried out a certain time after the product registration.

The product search unit 22 searches over the products registered in the product DB 40 to select a desired product. This search is performed based on a keyword, a project management number, a product management number or the like accepted by the product search unit 22.

The know-how map registration unit 31 accepts a know-how map registration request to acquire a necessary know-how from a product to register the know-how map in the know-how map DB 50.

The know-how map updating unit 32 updates the know-how maps registered in the know-how map DB 50 in response to an instruction from the product registration unit 21. Specifically, the know-how map is updated in accordance with a condition recorded in the know-how map for management and the know-how contained in the registered product.

The know-how map reference unit 33 refers to the know-how map for provision registered in the know-how map DB 50 in response to the instruction from the product registration unit 21. Then, the provision conditions to provide the know-how contained in the product are retrieved. Further, the information to identify the know-how managed in a (later-described) relevant know-how map related to the updated know-how map is retrieved. The know-how map reference unit 33 delivers these provision conditions and so forth to the know-how providing unit 34 to let the know-how providing unit 34 perform a selection, provision and so forth of the know-how.

The know-how providing unit 34 selects required product and know-how from the product DB 40 and the know-how DB 60 based on the know-how map for provision, sets priorities and provides them. This provision is carried out, for example, by storing the know-how in a storage device of a computer of a person desiring to be provided via a network. Note that the provision destination can be recorded in the know-how map for provision.

In the present mode, the update of the know-how map in the know-how map DB 50 is performed by the know-how map updating unit 32 using the registration of the product by the product registration unit 21 as a trigger. Also, using this product registration as a trigger, the reference unit 33 refers to the know-how map for provision, and furthermore the know-how providing unit 34 selects and provides the know-how.

When the person who is provided with the know-how is a member of some project, he/she can acquire relevant know-how previously in accordance with the progress of the project, so that the project can be processed effectively. Moreover, when the entity which is provided with the know-how is a service provider, the provider can prepare in advance the know-how usable for a customer service.

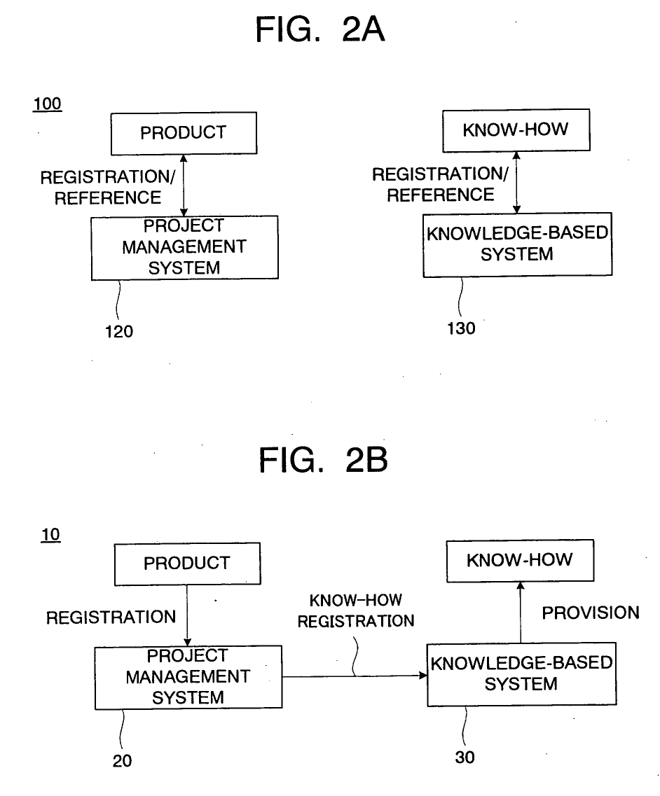

FIG. 2 are views showing an outline of a know-how provision in the project information providing system 10 and that in a conventional system by comparison. FIGS. 2A and 2B show the outline in a conventional system 100 and that in the project information providing system 10 according to the present mode, respectively.

As shown in FIG. 2A, the conventional system 100 is configured to have a project management system 120 and a knowledge-based system 130, as an independent system, respectively. The project management system 120 is a system managing the progress and products of the project, in which those products generated along with the progress of the project are managed. The knowledge-based system 130 manages know-how separately from the project management system 120.

On the other hand, in the project information providing system 10, the management and provision of the know-how are performed using the registration of a product as a trigger, on the basis of an interlocked operation of the project management system 20 and the knowledge-based system 30. Accordingly, the know-how storage and provision are performed rapidly.

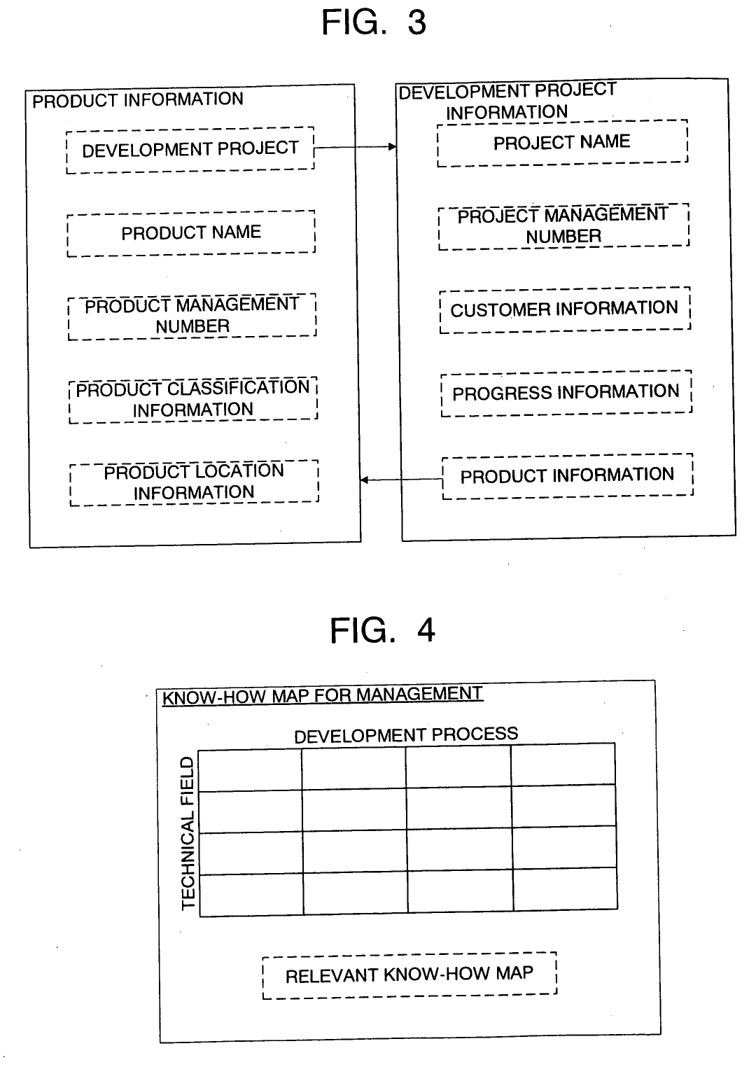

FIG. 3 is a conceptual view showing an example of the products to be registered in the product DB 40 by the product registration unit 21.

The project management system 20 manages products in a project. When the product is registered in the product DB 40, product information being information to manage the product is generated. The product information includes information related to the property and location of the product.

As “product information”, there are a “development project” (a project identification information such as a project management number of the project related to the product, or the “development project information” itself), a “product name”, a “product management number” (a kind of the product identification information identifying the product from each other, the number being a unique management number in the project information providing system 10), a “product classification number” (a classification showing the type of the product), and a “product location number” (information showing the location of the product itself), as examples.

As “development project information”, there are a “project name”, a “project management number” (a kind of the project identification information identifying the project from each other, the number being a unique management number in the project information providing system 10), a “customer information” (information related to the destination of the system developed and provided by the project), a “progress information” (information related to the progress of the project), and a “product information”, as examples. Specifically, here, the “development project information” includes the “product information”. Note that information (for example, the product management number) indicating a corresponding relation of the project and the product may be included in the development project information instead of the “product information”.

The project may be stored (managed) in the project information providing system 10 itself or in anywhere other than the project information providing system 10. When the project information providing system 10 manages the product, the product location information can be represented by a pass showing the directory where the product file is stored or an URL (UNIFORM Resource Locator). Meanwhile, when the product is managed as a paper document (paper-based), the product location information can be represented by the name of the administrating department, the name of the responsible person, an e-mail address or a telephone number.

Subsequently, the description will be given of the details of the know-how map. The know-how map is information to manage the know-how. The know-how map is divided into two types, namely the know-how map for management being a criterion in managing the know-how contained in the product and the know-how map for provision being a criterion in providing the know-how.

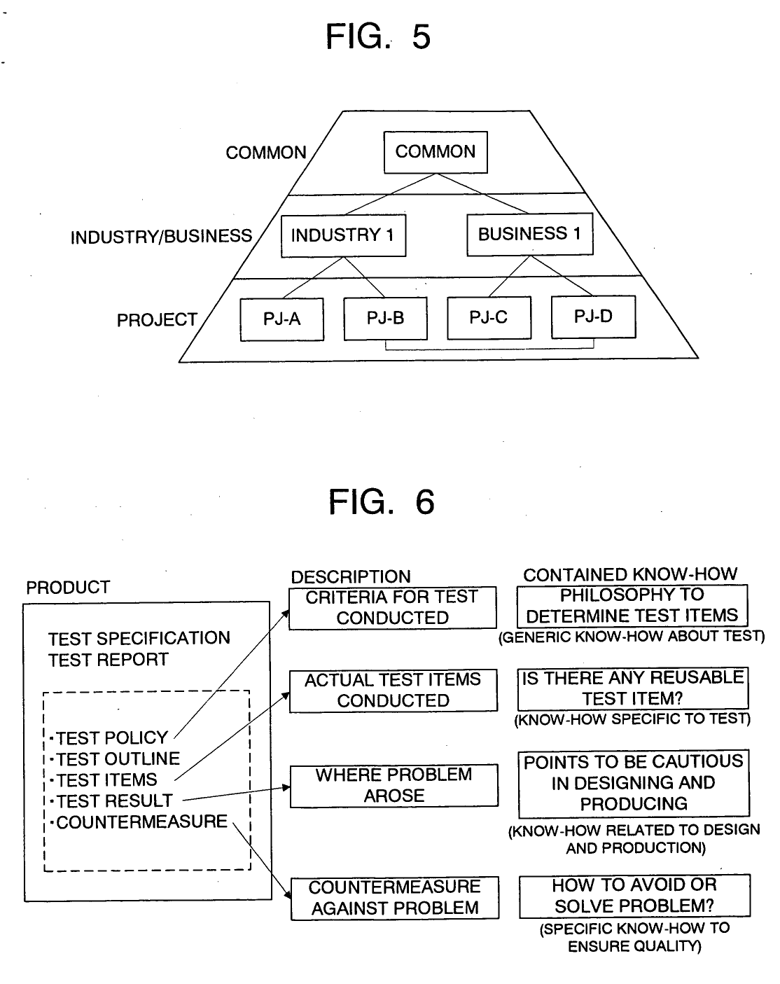

FIG. 4 is a schematic diagram showing an example know-how map for management. In this example, the know-hows are managed by being classified by a combined two elements (criteria for managing the know-how) of “development process” and “technical field”. Further, a “relevant know-how map” related to the know-how map for management is linked to the know-how map for management.

In the case of the program development, the “development process” can be classified into a program design (decision on program specification or the like), a program production and a program test. Note that the program development is frequently conducted by being classified into modules, so that the design, production and test can be further segmented into the designs, productions and tests of the module level.

The “technical field” can be classified on the basis of the program details such as a database, image processing, communication, POS (point-of sale) and so forth, as examples.

In the know-how map for management shown in FIG. 4, for the product containing know-hows, plural development processes and technical fields are designated, respectively, so that the product is managed by the contained know-hows corresponding to the designated development processes and technical fields.

The know-how map for management shown in FIG. 4 is a two-dimensional map having a combinatorial structure composed of two elements, however, the know-how map maybe a three or more dimensional map classified into three or more elements.

As elements thereof, other than the above, a language used for development (C++, Java (registered trademark) and soon), a system size involving the program to be developed (a standalone (a single computer), a small-sized network or a large-sized network) and so forth can be considered.

As a “relevant know-how map”, a know-how map of a higher level or a lower level with respect to the know-how map for management, and a know-how map of a relevant project can be considered.

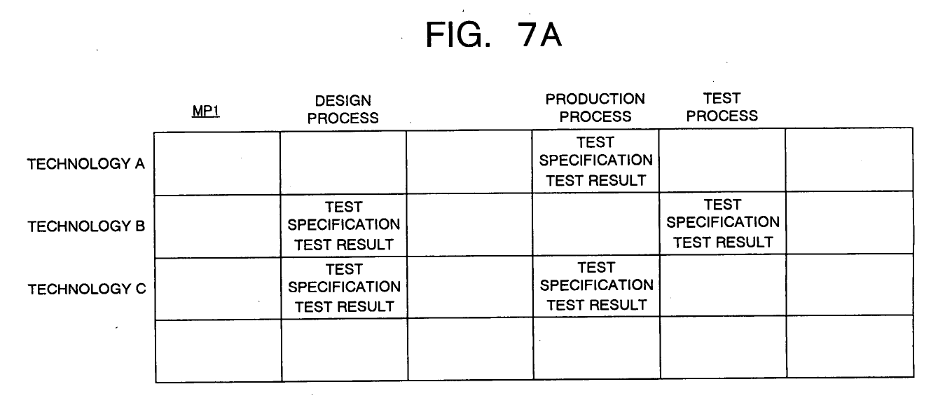

FIG. 5 is a schematic diagram showing a hierarchical structure (management pattern) of the know-how map.

The know-how map in FIG. 5 is segmented into a superior position, a middle position and a subordinate position by a “project” for each project, an “industry/business” for each industry/business and a “common” being common for every project. Specifically, an “industry 1” positions superior to a “PJ-A” and a “PJ-B”; a “business 1” positions superior to a “PJ-C” and a “PJ-D”; and a “common” positions superior to the “industry 1” and “business 1”. In short, the higher the element for the know-how management positions, the more generic concept the element has.

In the subordinate position of the know-how map, individual and specific know-hows are managed; and in the superior position thereof, generic know-hows are managed. Generally, the more specific the know-how is, the higher is the application effect, while the applicable scope tends to be smaller. On the other hand, when the know-how is made to be common to broaden the applicable scope, the effect itself tends to be smaller. The know-how map performs a hierarchical management in accordance with the applicable scope. Specifically, in the subordinate level of the know-how map, the know-hows with a smaller applicable scope but with a high added-value if applied, and in the superior level thereof, the know-hows with a large applicable scope are managed.

The know-hows to be stored are in a relation in which the part common with the subordinate know-how map is escalated to the know-how map being superior thereto. Thus, with the combinational use of the superior and subordinate know-how maps, a combinational use of the know-how with a large applicable scope and that with a high effect is possible.

By registering know-how maps, which are superior and subordinate to a know-how map for management, in the relevant know-how map shown in the know-how map for management in FIG. 4, the hierarchical use of the know-how maps is enabled.

For instance, in the case where the know-how map for management is the “industry 1” shown in FIG. 5, the subordinate “PJ-A” and “PJ-B” are registered as the relevant know-how maps. As a result, it is possible to refer to more specific know-how from the subordinate know-how maps. Further, by referring to the superior “common” know-how map as the relevant know-how map, it is possible to refer to the know-how being usable in common over a company. Further, in the case where the know-how map for management is the “PJ-B”, by registering “PJ-A” and “PJ-D”, which are related to project(s) being similar to the “PJ-B”, as the relevant know-how maps, the “PJ-A” and “PJ-D” can be referred to in addition to the “PJ-B”.

By giving priorities to the relevant know-how maps, it is possible to handle them in accordance with their priorities. For instance, in the case where the know-how map for management is the “PJ-B”, by defining the know-how map “PJ-A” of the relevant project as priority 1 and the superior know-how map “industry 1” as priority 2, the know-hows contained in the product can be classified in accordance with their priorities. With the priorities, it is possible to confirm the know-hows in order from those of higher priorities or to eliminate those of lower priorities, when receiving the know-hows.

As described above, the description has been given to the know-how map for management, whereas the same is also realizable in the know-how map for provision in the same manner.

Here, it is also possible to integrate the know-how map for management and the know-how map for provision into a single know-how map, so that the registration and provision of the know-how can be performed in the same know-how map. For instance, when the know-how map is of a certain project, and the person to receive the know-how is a member of the project, the integration of the know-how maps raises no problem. By integrating the know-how map for management and the know-how map for provision, both the know-how maps can be updated at once, so that an efficient update of the know-how maps can be enabled.

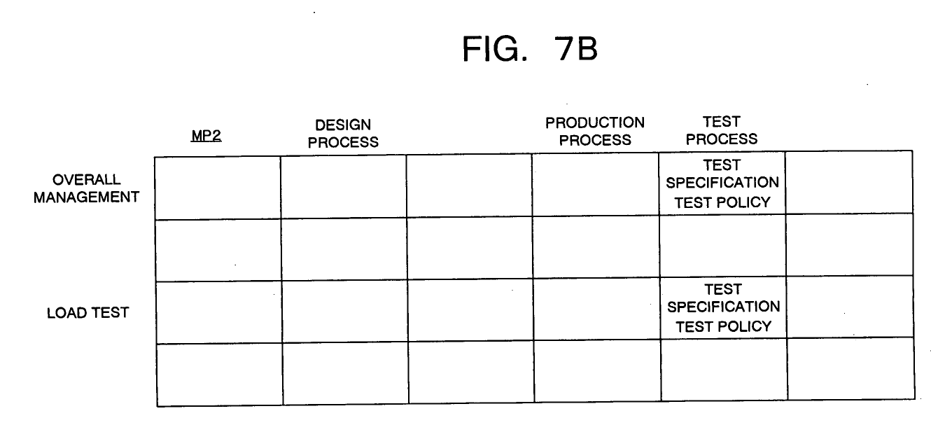

FIG. 6 is a schematic diagram showing a relation between the product and the know-hows contained in the product in the case where the product is the test specification and the test report. The test specification is a product in the prior stage to the test process and the test report is a product at the completion of the test process. These products contain items such as a “test policy” (the criteria for the test conducted), a “test outline” (global image of the test), “test item(s)” (actual test item(s) conducted), a “test result” (where problem arose), a “counter measure” (countermeasure against problem)

The product contains know-hows.

For instance, the “test policy” contains a generic know-how about the test “a philosophy to determine test items” that can be used as a base of the test environment or test coverage level in a similar system.

The “test items” contain a know-how specific to the test “Is there any reusable test item?”, in which the test items themselves can be diverted in the system exhibiting a higher similarity. This is not limited only to the test items, and when the test program can be diverted, substantial laborsaving effect can be obtained.

The “test result” contains know-how related to design and production “points to be cautious in designing and production”. For instance, the point tends to be rejected in a test, namely the point to be cautious in the design and production can be confirmed.

The “countermeasure” contains specific know-how to ensure quality “How to avoid or solve a problem?” in which a modification to the rejected test item possibly becomes a reference when coping with a trouble.

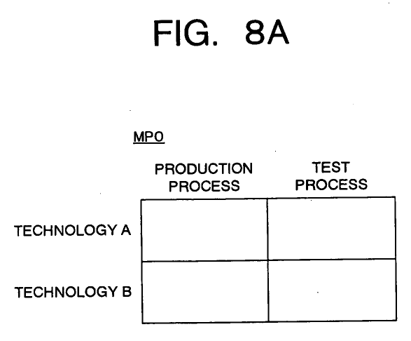

FIG. 7 show example know-how maps. Here, the product is assumed to be a test specification and test report as in the case of FIG. 6.

FIG. 7A and FIG. 7B are views showing a know-how map MP1 at a certain hierarchical level and a know-how map MP2 at a superior level thereto, respectively. The know-how maps MP1 and MP2 are updated at every registration of products so as to correspond to the know-how contained in the products.

The product is registered first to a subordinate know-how map (FIG. 7A) in accordance with the know-how contained therein. This know-how map is classified into individual technologies A, B, C.

Also, the product is categorized based on the superior concept using the superior know-how map (FIG. 7B). Here, the product is classified into elements of “overall management” and “load test”.

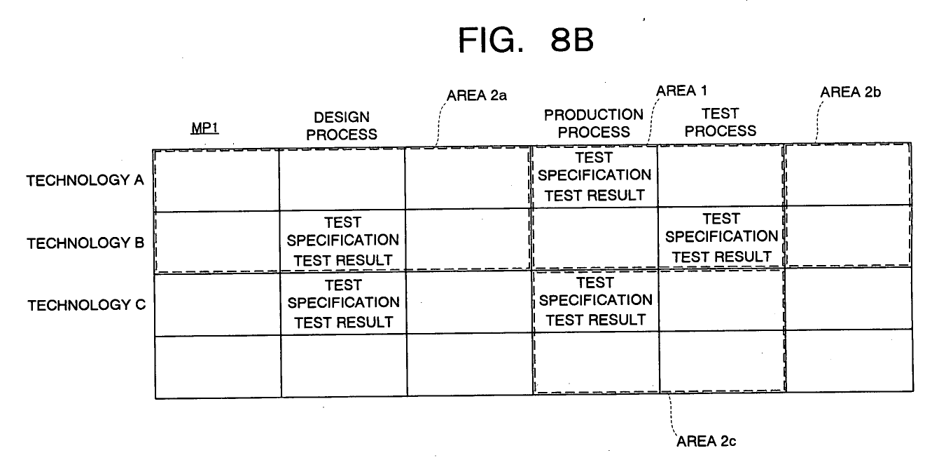

FIGS. 8A to 8C are schematic diagrams showing examples of a know-how map for provision MP0 (ZERO), and the know-how maps for management MP1, MP2 related thereto, respectively. In the examples, the know-how map for provision MP0 (ZERO) refers to the know-how maps for management MP1, MP2. As a result, the know-how map for provision MP0 (ZERO) and the know-how maps for management MP1, MP2 can be used for selecting know-how for provision.

The know-how maps MP1, MP2 are assumed to be the same as the know-how maps MP1, MP2 shown in FIGS. 7A and 7B.

Note that the know-how map for provision MP0 (zero) is not necessarily have the same form as of the know-how maps for management MP1, MP2; whereas in the present example, the know-how map for provision MP0 (zero) is assumed to have the same form as of the know-how maps for management MP1, MP2 in view of the structure segmented by two-dimensions of “development process” and “technical field”.

The case, in which priorities are given to the know-hows selected by the know-how maps for management MP1, MP2, will be shown.

As an example, priorities are given in the following manner.

(1) Priority 1: out of the know-hows in the subordinate know-how map for management MP1, those know-hows of which both the development process (“production process” and “test process”) and technical field (“technology A” and “technology B”) are the same as of the know-how map for provision (area 1).

(2) Priority 2: out of the know-hows in the superior know-how map for management MP2, those know-hows of which both the development process and technical field are the same as of the know-how map for provision (area 3).

(3) Priority 3: out of the know-hows in the subordinate know-how map for management MP1, those know-hows of which both the development process and technical field are the same as of the know-how map for provision (“overall management” is assumed to include “technology A” and “technology B”) or those know-hows including the same (area 2a, 2b, 2c).

(4) Priority 4: out of the know-hows in the superior know-how map for management MP2, those know-hows of which both the development process and technical field are the same as of the know-how map for provision or those know-hows including the same (area 4a, 4b, 4c).

Subsequently, the description will be given of a utilization method of the know-how maps.

By referring to the subordinate know-how map for management MP1, it is possible to refer to the know-hows related to the production, test process and technologies A, B in the know-how map MP1. Here, it is found that, from the test result of the test specification, those know-hows in the production process and related to the technology A as well as, from the test items of the test specification, those in the test process and related to technology B are available.

When necessary information cannot be obtained in the subordinate know-how map for management MP1, it is possible to refer to the commonly usable know-hows related to the production, test process and overall management by referring to the superior know-how map for management MP2. From the test policy of the test specification, it is possible to refer to know-how in the test process and related to the overall management.

In this manner, by classifying the know-hows in accordance with their priorities, it is possible to know the coverage of the required know-how as a reference.

(Operation of the Project Information Providing System 10)

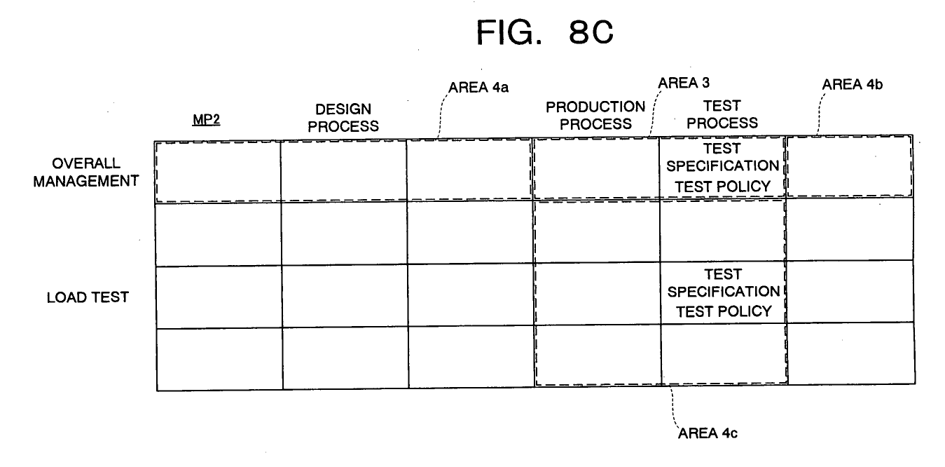

FIG. 9 is a flowchart showing an outline of operating procedures of the project information providing system 10. The operating procedures of the project information providing system 10 will be described with reference to the drawing.

(1) Product Registration (Step 10)

Along with the progress of a project, a project member registers a product using the product registration unit 21. As a result, the information of the product itself is registered in the product DB 40, for example, in the form as shown in FIG. 3.

At the time of the product registration, as required, the information indicating the progress of the project, for example, the specific status of the development process over the designing, production and test, is inputted. Note that the know-how map used here is the one previously registered by the know-how map registration unit 31.

(2) Know-How Registration (Step 20)

The product registration unit 21 registers products, and at the same time, gives an instruction to the know-how map updating unit 32 to update the know-how map. As a result, the know-how map for management is updated using the acceptance of the product registration as a trigger. For instance, the know-how map in FIG. 4 managed in a hierarchical manner as shown in FIG. 5 is updated to be those in FIGS. 7A and 7B.

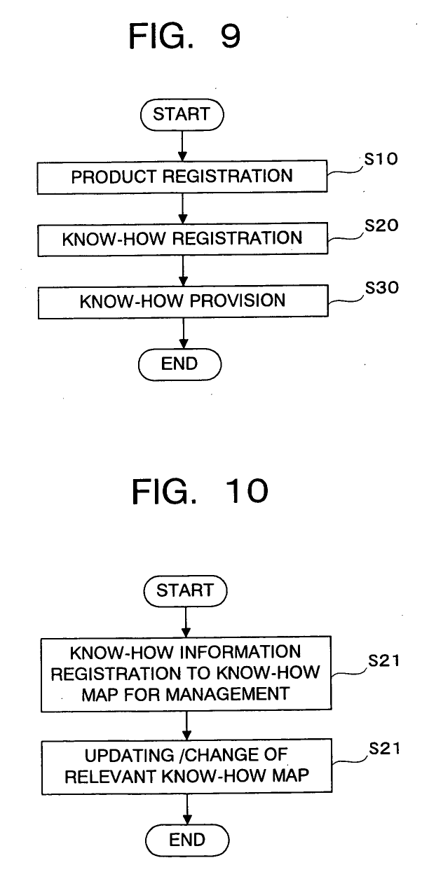

FIG. 10 is a flowchart showing detail procedures of the know-how map updating processing by the know-how map updating unit 32. Hereinafter, the description will be given based on FIG. 10.

Corresponding to the know-how contained in the product, the product is shown in the know-how map for management (Step 21). Specifically, the product location information, the product keyword and the like are recorded in the know-how map.

As required, the relevant know-how map related to the know-how map for management is changed (Step 22).

In response to the update of the know-how map, a collation is performed with the relevant know-how map to establish an association with the know-how map of which know-how can be diverted most easily. Note that this association change can be performed by referring to a table or the like in which a change condition was recorded.

When the product registration is performed as described above, the know-how thereof is managed by being indicated in the know-how map such that the know-how belongs to which development process and technical field. It is possible to indicate the know-how in the form of embedding in the know-how map table, so that the know-how that the project holds or does not hold becomes visible.

(3) Know-How Provision (Step 30)

The product registration unit 21 gives an instruction to boot the know-how map reference unit 33 at the same time of booting the know-how map updating unit 32. As a result, a know-how provision is performed using a product registration as a trigger.

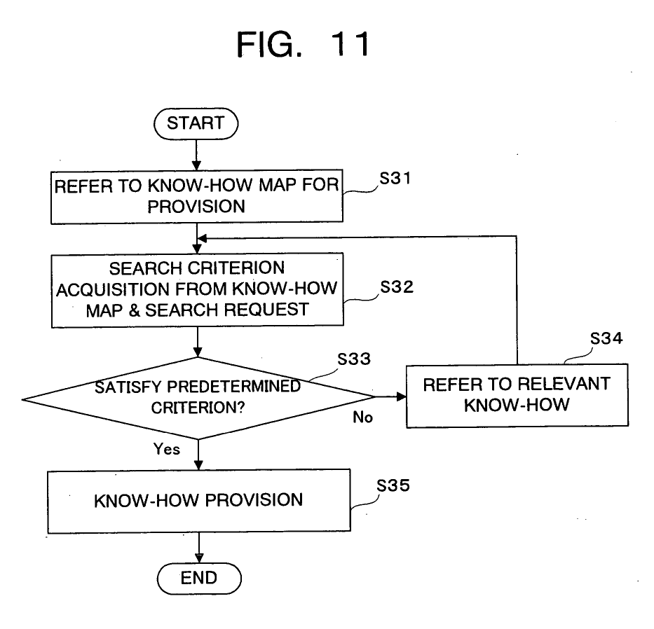

FIG. 11 is a flowchart showing the procedures of the know-how provision performed by the know-how map reference unit 33. Hereinafter, the description will be given based on FIG. 11.

a. the know-how map reference unit 33 refers to the know-how map for provision (Step S31), and sets a search criterion to thereby issue a search request for know-how to the know-how providing unit 34 (Step S32).

b. the know-how providing unit 34 accepted the request searches know-how from the product DB 40 and know-how DB 60 based on the search criterion to determine whether or not the search satisfying the predetermined criterion is possible (Step S33).

The predetermined criterion is, for example, the upper limit or lower limit of the number of pieces to search. Further, by combining the number with the search criterion, it is possible to set the upper or lower number to search for each single search criterion or for a combined plural search criteria. Further, the priorities can be set to the predetermined criteria. For instance, the search result of the combined plural criteria (technical field and development process) can be prioritized rather than the search result of a single criterion (technical field or development process).

When the search cannot satisfy the predetermined criterion, the search is performed again using the relevant know-how map (Step S34). Note that the relevant know-how map may be given the priorities and the search may be performed in the order from the highest priority.

The provision of searched out know-how is performed (Step S35).

This know-how provision can be realized by any of the provision of the products accumulated in the product DB 40 or the provision of the know-hows accumulated in the know-how DB 60. The reason is that the provision of the product also means the provision of the know-how contained therein.

At that time, with the weight of the search criterion, it is possible to provide know-how in accordance with the priorities from highly applicable know-how to further generic know-how.

As described above, it is possible to provide information in accordance with the status of the service receiver by weighting on information seemed to be required.

In the project information providing system 10 described above, the know-how map for management and the know-how map for provision can be used differently. For instance, by comparing the know-how map for provision registered in advance in accordance with customer requirements and the updated know-how map for management as in FIG. 8, it is possible to provide know-how to a system user such as the service provider by setting priorities in accordance with the customer requirement. The service provider acquires the know-how that is prioritized in accordance with the customer requirement as needed, so that the service provider can provide high-quality services backed by know-how to customers.

Meanwhile, the know-how map for provision and the know-how map for management can be integrated to be used in common. This is appropriate in the case of feeding back the provided know-how directly to a development project member.

Additionally, with this integration of the know-how map for management and the know-how map for provision, the productivity of the development project can be increased on the back of a further simplified system. Specifically, with the integration of schemata of the know-how maps as well as the know-how maps themselves, the know-how to efficiently carry out the subsequent development process can be acquired in response to the product registration of each single development process.

### INDUSTRIAL APPLICABILITY

The project information providing system and the project information providing method according to the present invention enables a rapid and efficient provision of information on a project product, and can be produced and implemented from an industrial point of view.

What is claimed is:

1. A project information providing system, comprising:
a product registration unit registering a product of a project;
an information management unit managing information contained in the product using the registration of the product by said product registration unit as a trigger; and
an information providing unit selecting and providing information contained in the product using the registration of the product by said product registration unit as a trigger.

2. The project information providing system as set forth in claim 1,
wherein the information managed by said information management unit is classified based on a predetermined table.

3. The project information providing system as set forth in claim 1,
wherein the table records information enabling to refer to a content recorded in other table.

4. The project information providing system as set forth in claim 3,
wherein the table has a hierarchical relation with the other table.

5. The project information providing system as set forth in claim 1,
wherein the table records information indicating priorities used to select or provide information.

6. A project information providing method, comprising:
a step of product registration registering a product of a project;
a step of information management managing information contained in the product using the registration of the product in said product registration step as a trigger; and
a step of information provision selecting and providing information managed in said information management step.
